(19) United States
(12) Patent Application Publication
(10) Pub. No.: US 2015/0100823 A1
(43) Pub. Date: Apr. 9, 2015

(54) DATA BACKUP METHOD AND INTERFACE CARD

(71) Applicant: FUJITSU LIMITED, Kawasaki-shi (JP)

(72) Inventors: Yoshinori MATSUNAGA, Yokohama (JP); Masanori TAKAOKA, Kawasaki (JP); Masakazu YABE, Setagaya (JP)

(73) Assignee: FUJITSU LIMITED, Kawasaki-shi (JP)

(21) Appl. No.: 14/568,589

(22) Filed: Dec. 12, 2014

Related U.S. Application Data
(63) Continuation of application No. PCT/JP2012/067240, filed on Jul. 5, 2012.

(51) Int. Cl. G06F 11/14

(52) U.S. Cl. CPC G06F 11/1451; G06F 2201/84
USPC 714/19

(57) ABSTRACT

Equipping a first computer with an interface card having an access function of accessing a storage and a communication function of performing a communication via a network. Connecting the interface card equipped in the first computer and a second computer by the network. Causing the interface card to process target data received from the second computer and to cause the target data to be saved in a first storage, which is a storage connected to the interface card, when the second computer transmits the target data to be saved to the interface card.

### CROSS-REFERENCE TO RELATED APPLICATION

This application is a continuation application of International Application PCT/JP2012/067240 filed on Jul. 5, 2012 and designated the U.S., the entire contents of which are incorporated herein by reference.

### FIELD

The embodiments discussed herein are related to a technology of data backup for saving the same data at different sites.

### BACKGROUND

It is possible for a fault or the like to occur in a storage used to store data of a computer, and the data can be possibly infected with a virus. Both a fault in a storage and infection with a virus cause a loss of data. Accordingly, it is preferable to back up data in another storage.

A fault in a storage can be possibly caused by a natural disaster such as an earthquake, a typhoon, a tornado, a flood, a tsunami or the like. For this reason, it is desirable to designate, as a backup destination, a site remote from that in which the data is saved. Therefore, if a site selected as a backup destination is not sufficiently remote, it is desirable to newly designate a site more remote from that in which the data is saved as a backup destination.

[Patent Document 1] Japanese Laid-open Patent Publication No. 2006-338064

[Patent Document 2] Japanese Laid-open Patent Publication No. 10-320286

### SUMMARY

According to an aspect of the embodiments, a data backup method including equipping a first computer with an interface card having an access function of accessing a storage and a communication function of performing a communication via a network, connecting the interface card equipped in the first computer and a second computer by the network and causing the interface card to process target data received from the second computer and to cause the target data to be saved in a first storage, which is a storage connected to the interface card, when the second computer transmits the target data to be saved to the interface card.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a configuration of a network system to which a data backup method according to an embodiment is applicable.

FIG. 2 illustrates an example of a configuration of a computer used as a master computer or a slave computer.

FIG. 3A is an explanatory diagram of an example of content of an IP table saved in a dedicated HBA placed in a master mode.

FIG. 3B is an explanatory diagram of an example of content of an IP table saved in a dedicated HBA placed in a slave mode.

FIG. 4 is an explanatory diagram of packets transmitted and received between a master computer and a slave computer.

FIG. 5 is a flowchart that represents a flow of a process executed by computers when data is backed up.

FIG. 6 is a sequence diagram for explaining packets transmitted and received between computers, and data inputs and outputs performed between components of the computers.

FIG. 7 is a flowchart that represents a flow of a process executed by computers when data is read.

FIG. 8 is a sequence diagram for explaining packets transmitted and received between computers, and data inputs and outputs performed among the components of the computers.

### DESCRIPTION OF EMBODIMENTS

Embodiments are described in detail below with reference to the drawings. Hereinafter, for the sake of convenience, data to be backed up and backed up data are referred to as “original data” and “backup data”, respectively.

Original data is updated suitably. An update of original data is reflected in backup data. Thus, for data backup, a system configuration in which a computer accessible to original data and a computer used to save backup data are connected via a network is conventionally adopted. In this system configuration, original data after being updated is transmitted from one computer to the other. In this way, the original data after being updated can be saved as backup data in the other computer suitably. For the sake of convenience, a computer accessible to original data and a computer that saves backup data are hereinafter referred to as a “first computer” and a “second computer”, respectively.

In the above described system configuration, the second computer is set up at a backup destination. The first computer transmits original data to the second computer suitably, and the second computer updates backup data by receiving the original data from the first computer. Therefore, software for data backup is installed in each of the first computer and the second computer. To newly secure a backup destination, at least one of a computer used as the second computer or the software is purchased. Moreover, the length of time to set up the second computer is long. The reason why the length of time to set up the second computer becomes long is to make the second computer available. The setup operations also include securing and a placement of a setup site, an installation of software, and the like. Accordingly, not only the cost of building a data backup environment but the length of time taken to build a data backup environment increases.

Nobody knows the time at which a data loss will be caused to occur. Therefore, it is desirable so as not to eliminate the possibility that a natural disaster causing a data loss can occur at any moment. In consideration of this possibility, it is desirable that a data backup environment be built quickly.

An existing computer may be used as the second computer. However, a load imposed on the existing computer is increased by adding a data backup function. Accordingly, this can possibly affect a process to be originally executed. For this reason, it is sometimes preferable that an existing computer not be used as the second computer.

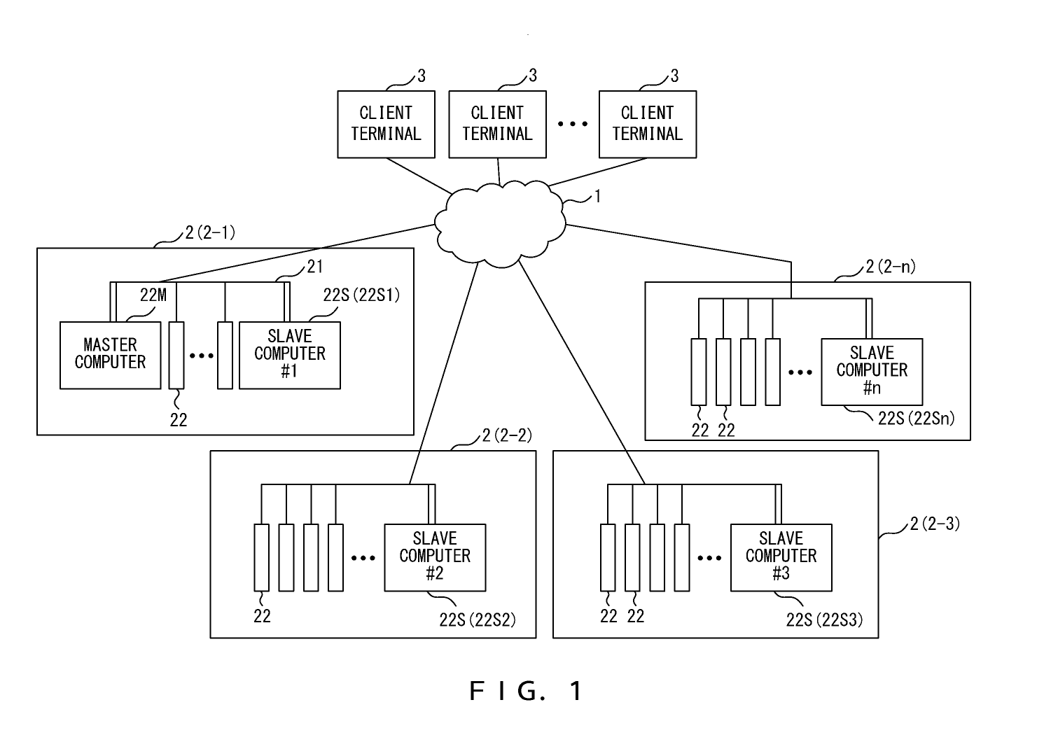

FIG. 1 illustrates an example of a network system to which a data backup method according to an embodiment is applicable. As illustrated in FIG. 1, in the above described network system, a plurality of computer systems 2 (2-1 to 2-n) built in a data center, a server room or the like, and terminal devices 3 respectively used by users are connected, for example, to a wide area network (WAN) 1. The terminal devices 3 are denoted as client terminals in FIG. 1.

Each of the computer systems 2 is a system for rendering a desired service or the like to a user of the terminal device 3 connected via the WAN 1. As illustrated in FIG. 1, each of the computer systems 2 includes, for example, a local area network (LAN) 21 and a plurality of computers 22 connected to the LAN 21. The LAN 21 is connected to the WAN 1 via a relay device not illustrated. Each of the computers 22 is used, for example, as a server.

In FIG. 1, a “master computer” and a “slave computer” are denoted as names of the computers 22. 22M and 22S (22S1 to 22Sn) are denoted as reference numerals of the master computer and the slave computers. As described above, some of the computers 22 are distinguished from the other computers. This is because the group of computers 22 to which the data backup method according to this embodiment is applied, namely, a combination of the master computer 22M that manages original data and one or more slave computers 22S that save the original data as backup data, is clarified.

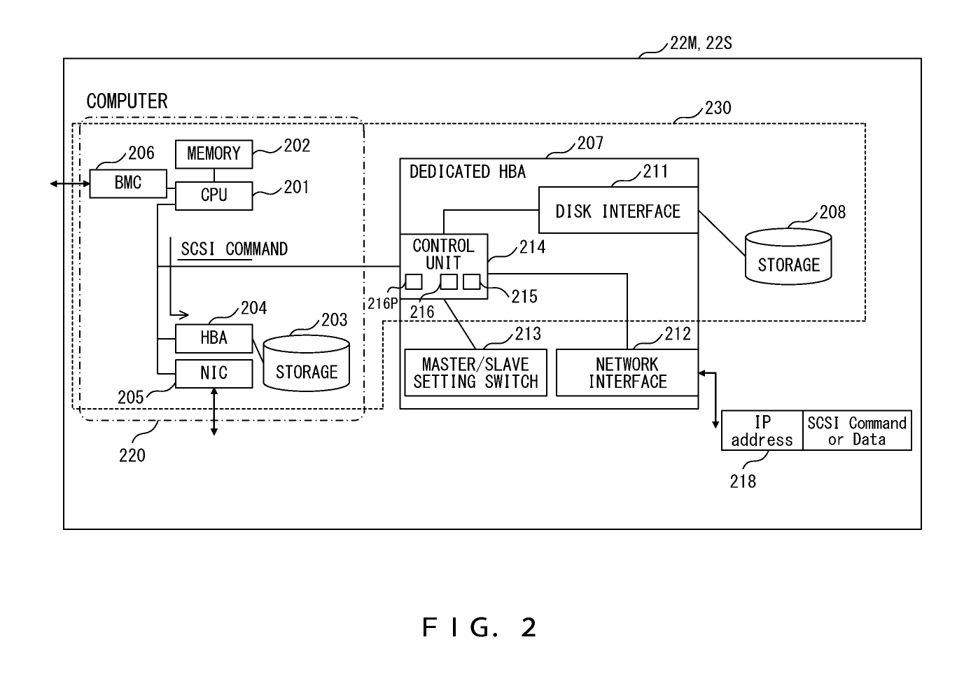

FIG. 2 illustrates an example of a configuration of a computer used as the master computer or the slave computer.

Each of the computers 22 connected to the LAN 21 includes a central processing unit (CPU) 201, a memory 202, a storage 203 such as a hard disk device or the like, a host bus adapter (HBA) 204, a network interface card (NIC) 205, and a baseboard management controller (BMC) 206 as illustrated in FIG. 2.

The memory 202 is a storage that the CPU 201 uses as a working memory. The storage 203 is used to store programs executed by the CPU 201, such as an operating system (OS), and various types of application programs (hereinafter abbreviated to “applications”). The storage 203 is connected to the HBA 204, and the CPU 201 accesses the storage 203 via the HBA 204. The NIC 205 is connected to the LAN 21, and enables a communication via the LAN 21. The BMC 206 is a management device that monitors and diagnoses states of units according to environmental conditions such as a temperature and a voltage. The BMC 206 is connected to an external management device not illustrated, with for example a dedicated line, and powers on and off the computer 22 according to an instruction issued from the external management device.

In the computers 22 connected to the LAN 21, an extension slot is provided internally. Inmost of the computers 22, an extension slot can be provided externally. The computer used as the master computer 22M or the slave computer 22S is equipped with an HBA 207, which is an interface card according to this embodiment. The HBA 207 is denoted as a “dedicated HBA” in FIG. 2. The HBA 207 is hereinafter referred to as the “dedicated HBA” in order to make a distinction from the HBA 204.

The dedicated HBA 207 includes a disk interface 211, a network interface 212, a master/slave setting switch 213, and a control unit 214, as illustrated in FIG. 2.

The disk interface 211 is an interface that accesses a connected storage. Here, assume that one storage 208 is connected to the disk interface 211. A plurality of storages connected to the disk interface 211 may be provided, or a plurality of disk interfaces 211 themselves may be provided.

The network interface 212 is an interface that enables a communication performed via the LAN 21 illustrated in FIG. 1. Since the dedicated HBA 207 includes the network interface 212, the computer 22 equipped with the dedicated HBA 207 is connected by the LAN 21 and two LAN cables. In FIG. 1, two lines are depicted for the master computer 22M and the slave computer 22S.

The master/slave setting switch 213 is a switch for setting an operation mode of the dedicated HBA 207. In this embodiment, a master mode assumed to be implemented in the master computer 22M, and a slave mode assumed to be implemented in the slave computers 22S are prepared as the operation modes.

A user who is an administrator of the computer system 2 selects either of the master mode and the slave mode by using the master/slave setting switch 213. Here, it is assumed that a type for setting the mode by moving a position of a knob is the master/slave setting switch 213.

The control unit 214 detects the position of the knob of the master/slave setting switch 213, sets either of the master mode and the slave mode according to a result of the detection, and operates in the set mode.

The HBA 207 inserted into the extension slot is recognized by the CPU 201 according to a change in a PCI reset signal from “assert” to “deassert”. When the slave mode is set, the control unit 214 keeps the PCI reset signal in the assert state. When the master mode is set, the control unit 214 deasserts the PCI reset signal. When the slave mode is set, the CPU 201 recognizes resources within a range 220 enclosed with a dotted-dashed line in FIG. 2, and does not recognize the dedicated HBA 207. When the master mode is set, however, the CPU 201 recognizes resources within a range 230 enclosed with a dashed line in FIG. 2. Therefore, the CPU 201 also recognizes the dedicated HBA 207.

When the master mode is set, the CPU 201 recognizes the dedicated HBA 207, and also recognizes the storage 208 connected to the dedicated HBA 207. For that reason, the control unit 214 inputs and outputs data to and from the CPU 201 when the master mode is set. The dedicated HBA 207, however, does not cause the CPU 201 to recognize the presence of the network interface 212. The reason is as follows. This embodiment assumes that the dedicated HBA 207 uses the network interface 212 of the local dedicated HBA 207 for a communication performed for data backup and that the dedicated HBA 207 is caused to autonomously execute a data backup process. In this embodiment, data stored in the storage 208, namely, data input to the dedicated HBA 207 according to the control of the CPU 201, is regarded as original data to be backed up, so that the data backup process can be autonomously executed with ease. This means that original data is automatically backed up by using the storage 208 as a destination at which the original data is saved in the master computer 22M.

The computer 22, namely, the CPU 201, need not to recognize the network interface 212, which is a communication function of the dedicated HBA 207. The CPU 201 does not recognize the network interface 212, which is a resource that the CPU 201 need not to recognize, so that setup operations to be performed by the administrator when the dedicated HBA 207 is equipped in the computer 22 can be further simplified. The master computer 22M is implemented by equipping the computer with the dedicated HBA placed in the master mode.

In the meantime, when the slave mode is set, the CPU 201 does not recognize the dedicated HBA 207. Therefore, the dedicated HBA 207 is not to be controlled by the CPU 201, and autonomously operates at all times. Therefore, in this embodiment, the dedicated HBA 207 placed in the slave mode operates like one computer that manages backup data. Accordingly, the slave computer 22S, which is the computer 22 equipped with the dedicated HBA 207 placed in the slave mode, is merely used to supply power to the dedicated HBA 207 and to accommodate the dedicated HBA 207.

As described above, in this embodiment, the dedicated HBA 207 equipped in the master computer 22M and the dedicated HBA 207 equipped in the slave computers 22S are made to autonomously operate, so that data backup is realized. Neither the master computer 22M nor the slave computers 22S need to cause the CPU 201 to execute software for backup. In the master computer 22M, a load imposed on the CPU 201 does not increase, or slightly increases even if it becomes heavy. In the slave computers 22S, a load imposed on the CPU 201 does not increase because the CPU 201 does not recognize the dedicated HBA 207. Therefore, existing computers 22 that can accommodate the dedicated HBA 207 and the storage 208 are available unchanged as the master computer 22M and the slave computers 22S.

Both the master computer 22M and the slave computers 22S include the dedicated HBA 207. However, a cost to procure a demanded number of dedicated HBAs 207 and that of storages 208 are lower than a cost to procure one computer 22. The computer system 2 built in a data center or the like includes many computers 22, and there is a low possibility that none of the computers 22 will have an excess of extension slots in the computer system 2. Therefore, there is a high probability that an existing computer can be used as the master computer 22M or the slave computer 22S. For this reason, an environment for enabling data backup can be built at a low cost by using the dedicated HBA 207.

The dedicated HBA 207 placed in the master mode can obtain original data from the master computer 22M. However, the dedicated HBA 207 need not to be included in the computer 22.

The dedicated HBA 207 placed in the slave mode need not to be connected to the slave computer 225. Daringly, this embodiment assumes that an interface card is included within the computer 22 and a type of the interface card is HBA. One reason is that a device for building a data backup environment can be set up without reducing an available space in a data center or the like in which the computer system 2 is built. Another reason is that the computer system 2 is in an environment where a high-speed communication can be performed.

Due to the above described reasons, if a relatively large room is present in an available space, the interface card for the master computer 22M may be of a type set up outside the master computer 22M. The dedicated HBA 207 placed in the slave mode may be a dedicate device to which power can be supplied from a device other than the computer 22. As described above, the dedicated HBA 207 placed in the master mode and the dedicated HBA 207 placed in the slave mode may be implemented as devices of different types. Even if the dedicated HBAs 207 are implemented as interface cards of the same type, the interface cards for the master computer 22M and the slave computer 22S may be respectively commercialized.

Even if settings and the like for data backup are not carried out in the slave computers 22S, it does not matter as long as settings such as a setting for designating the storage 208 as a saving destination of original data are carried out in the master computer 22M. In the dedicated HBA 207, development of software for data backup and settings for a communication between dedicated HBAs 207 are carried out.

The development of software need not to be conducted according to a target computer 22 or client. Since the settings for a communication between the dedicated HBAs 207 are those for identifying a communication target for the data backup, operations are not complicated. Accordingly, a data backup environment can be quickly built with ease.

Note that the development cost of software may be recovered for each data backup environment built by using the dedicated HBA 207. Therefore, the cost to procure the dedicated HBA 207 can include the development cost of software. Accordingly, the development cost of software, which is included in the cost to procure the dedicated HBA 207, can be decreased as the number of dedicated HBAs 207 used to build a data backup environment increases.

In this embodiment, a table 215 for a communication between dedicated HBAs 207 is saved in each dedicated HBA 207. The IP table 215 is hereinafter referred to as an “IP table”.

This Internet Protocol (IP) table 215 is saved in a nonvolatile storage that is included in the control unit 214 and is not illustrated, along with for example a program 216 executed by the control unit 214. A function of the control unit 214 may be realized by executing the program by a processor 216P.

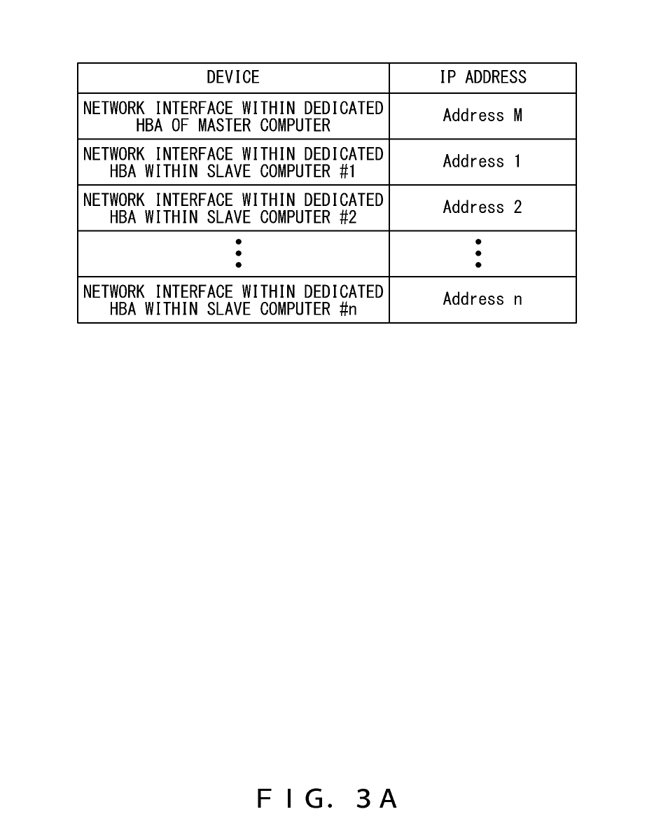

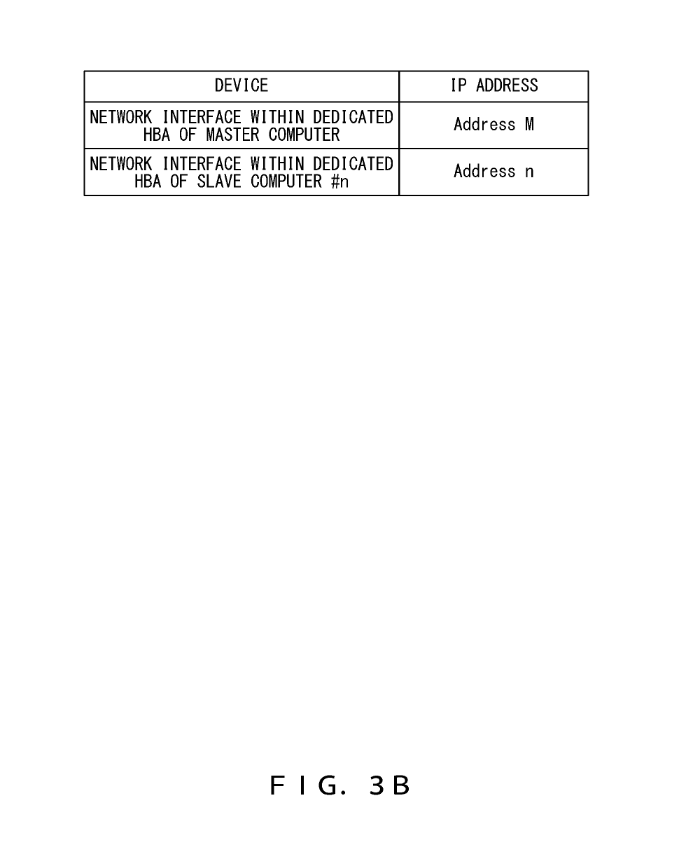

FIGS. 3A and 3B are explanatory diagrams of an example of contents of an IP table stored in a dedicated HBA. FIG. 3A illustrates the example of contents of the IP table 215 saved in the dedicated HBA 207 placed in the master mode, whereas FIG. 3B illustrates the example of contents of the IP table 215 saved in the dedicated HBA 207 placed in the slave mode.

As illustrated in FIGS. 3A and 3B, each entry of the IP table 215 stores device information that represents a dedicated HBA 207, and an IP address assigned to the dedicated HBA 207. For example, in FIG. 3A, a “network interface within a dedicated HBA of a master computer” denoting device information represents the network interface 212 of the dedicated HBA 207 equipped in the master computer 22M. “Address M” denoted in the same line represents an IP address assigned to the network interface 212. Similarly, a “network interface within a dedicated HBA of a slave computer #1” represents the network interface 212 of the dedicated HBA 207 equipped in the slave computer 22S1, and “Address 1” denoted in the same line represents an IP address assigned to the network interface 212.

In the IP table 215, a dedicated HBA 207 represented by the device information is the local dedicated HBA 207, or a different dedicated HBA 207 to be communicated by the local dedicated HBA 207. Thus, the IP table 215 stores setup information that sets up a different dedicated HBA 207 to be communicated by a dedicated HBA 207 in which the IP table 215 is held. The dedicated HBA 207 placed in the master mode enables all dedicated HBAs 207 in which original data is to be saved to communicate with each other. For the dedicated HBA 207 placed in the slave mode, a dedicated HBA 207 that transmits original data is basically a communication target. Thus, the IP table 215 held in the dedicated HBA 207 placed in the master mode stores information of all the dedicated HBAs 207 to be communicated, as illustrated in FIG. 3A. As illustrated in FIG. 3B, the IP table 215 held in the dedicated HBA 207 placed in the slave mode stores only information of the dedicated HBA 207 that transmits original data as the dedicated HBA 207 to be communicated.

For example, each entry of the IP table 215 stores flag information with which the local dedicated HBA 207 identifies a corresponding entry, although this is not particularly illustrated. Thus, the control unit 214 identifies an IP address assigned to the local dedicated HBA 207, and sets the identified IP address in for example the network interface 212 suitably.

For a communication performed by the dedicated HBA 207, a media access control (MAC) address is used in addition to an IP address. Thus, each entry of the IP table 215 also stores a MAC address.

The CPU 201 issues a command when it causes the dedicated HBA 207 to execute some process. Since the dedicated HBA 207 placed in the master mode is recognized by the CPU 201, the CPU 201 issues, to the dedicated HBA 207, a command of a type according to the process to be executed.

The issued command is input to the control unit 214 of the dedicated HBA 207, and the control unit 214 executes the process according to the input command. Here, it is assumed that a small computer system interface (SCSI) command is the command.

As described above, it is assumed that data of the storage 208 connected to the dedicated HBA 207, and more specifically, data newly stored in the storage 208, and data already stored in the storage 208 are original data in this embodiment. Moreover, in this embodiment, a process related to backup according to content of an access is executed at a timing at which the access is made to the storage 208 in order to read or write data. Thus, the dedicated HBA 207 of the master computer 22M, and the dedicated HBA 207 of each of the slave computers 22S, operate as follows according to the type of a SCSI command issued by the CPU 201 of the master computer 22M. The dedicated HBAs 207 are controlled by executing the program 216 by the processor 216P of the control unit 214.

An access to the storage 208, namely, a new data write to the storage 208, or a data read from the storage 208, is performed, for example, according to an instruction from the terminal device 3, or by a service rendered to a user of the terminal device 3. The timing at which a transition is made to a situation to access the storage 208 is not particularly limited. Also a type of data written to the storage 208 is not particularly limited.

When the storage 208 is caused to store data, the CPU 201 outputs data to be written to the dedicated HBA 207 along with a SCSI command that provides an instruction to write the data. The control unit 214 of the dedicated HBA 207 causes the storage 208 to store input data by outputting the input data to the disk interface 211 according to the input SCSI command.

When data is stored in the storage 208, an error detection code such as a cyclic redundancy check (CRC) code or the like, which is calculated from the data to be stored, is normally stored. Here, however, the presence of the error detection code is ignored for the sake of convenience of explanation.

Additionally, the control unit 214 references the IP table 215, generates a packet 218 for issuing a request to store input data, which is addressed to each dedicated HBA 207 in which the IP address is stored in the IP table 215, and outputs the generated packet 218 to the network interface 212. Thus, the control unit 214 causes the dedicated HBA 207 equipped in each of the slave computers 22S to backup the input data as original data.

Upon receipt of the packet 218 addressed to the local dedicated HBA 207 from the dedicated HBA 207 of the master computer 22M, the network interface 212 of the dedicated HBA 207 equipped in each of the slave computers 22S outputs the received packet 218 to the control unit 214. The control unit 214 references the IP table 215, and processes the packet 218 that can be verified as a packet addressed to the local dedicated HBA 207 by verifying whether the packet 218 input from the network interface 212 is addressed to the local dedicated HBA 207. Thus, the control unit 214 causes the storage 208 to store data by outputting the data stored in the input packet 218 to the disk interface 211 when the input packet 218 issues the instruction to write data. Thereafter, the control unit 214 generates a packet 218 for notifying the transmission source of the packet 218 of a result of execution of the process, and outputs the generated packet 218 to the network interface 212, which is caused to transmit the packet.

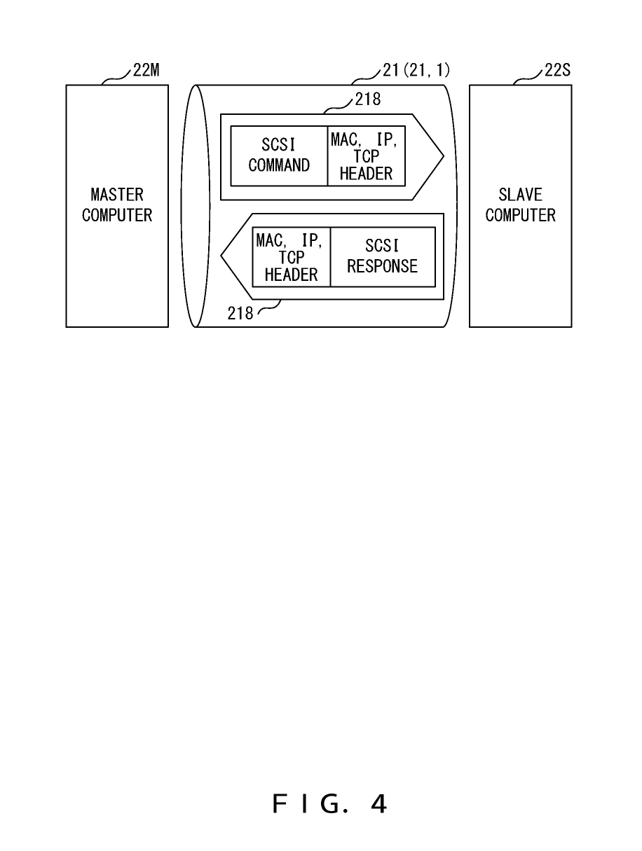

FIG. 4 is an explanatory diagram of packets transmitted and received between the master computer and the slave computer. The above described packets 218 are autonomously transmitted and received between the dedicated HBAs 207. Here, the master computer 22M and the slave computer 22S are represented as devices that transmit and receive the packet 218 in order to clarify a side that issues a request to back up data and a side to which the request to back up data is issued. As illustrated in FIG. 1, the packets 218 are transmitted and received between the master computer 22M and the slave computer 22S only via the LAN 21, or via the LAN 21 and the WAN 1.

Each of the above described packets 218 is a data transmission unit including a header part 218a and a data part 218b. The header part 218a stores a transmission control protocol (TCP) header, an IP header, and a MAC header. IP addresses of a transmission source and a transmission destination are stored in the IP header, and MAC addresses of the transmission source and the transmission destination are stored in the MAC header.

The data part 218b stores data to be transmitted to the transmission destination. The master computer 22M is always in a position to issue an instruction for a process to be executed to the slave computer 22S side. Therefore, a SCSI command is stored in the data part 218b of the packet 218 transmitted from the master computer 22M. For a SCSI command that provides an instruction to write data, data to be written is also stored in the data part 218b together with the command.

In the meantime, the slave computer 22S is the side that processes the SCSI command stored in the packet 218 received from the master computer 22M. Thus, the data part 218b of the packet 218 transmitted from the slave computer 22S stores data that represents a result of execution of the SCSI command. In FIG. 4, the data that represents the result is denoted as a “SCSI response”.

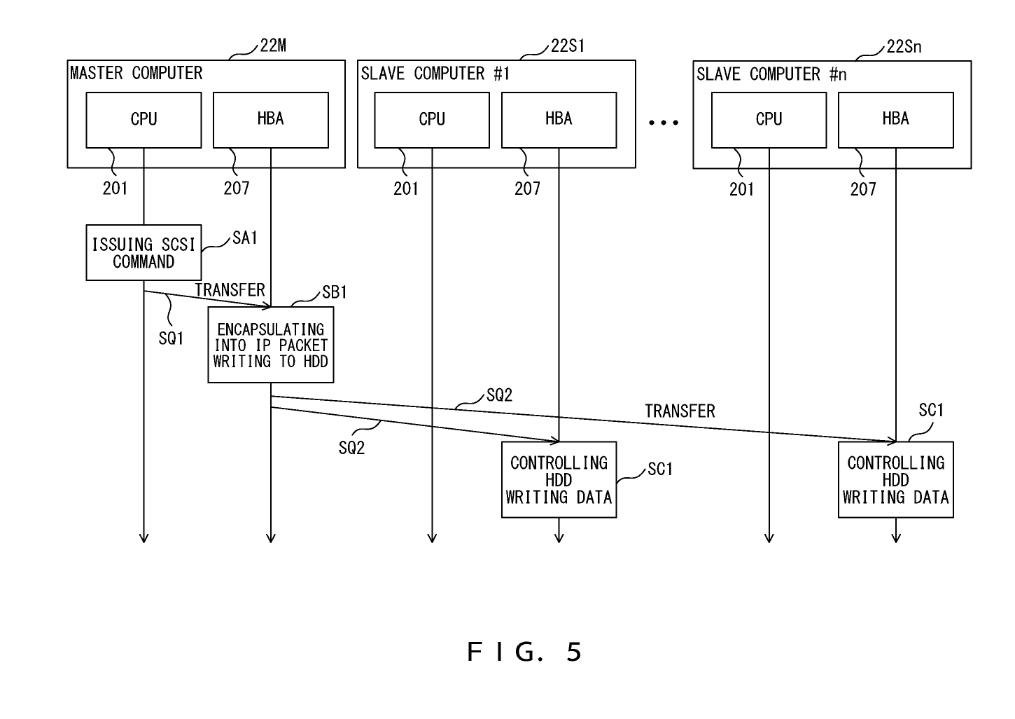

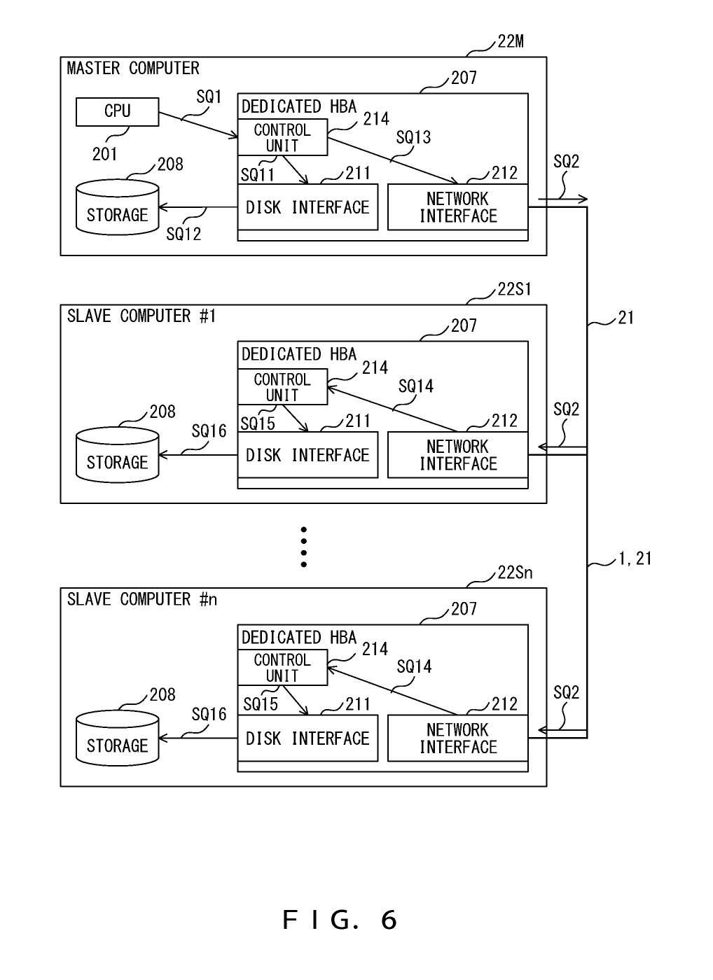

Here, operations of the master computer 22M and each of the slave computers 22S, which are performed when data is backed up, are specifically described with reference to FIGS. 5 and 6. FIG. 5 is a flowchart that represents a flow of a process executed by the computers when data is backed up, whereas FIG. 6 is a sequence diagram for explaining packets transmitted and received between the computers, and data inputs and outputs performed among units of the computers.

In FIG. 5, the CPU 201 and the dedicated HBAs 207 are illustrated as components that execute the process in each of the computers 22, namely, the master computer 22M and the slave computers 22S. The process illustrated in FIG. 5 is executed when the CPU 201 of the master computer 22M causes data to be written to the storage 208 as described above.

If a situation is gemerated such that the data is written to the storage 208, the CPU 201 of the master computer 22M issues a SCSI command for providing an instruction to write data, and transfers the issued SCSI command and the data to be written (SA1, SQ1). Thereafter, the CPU 201 makes a transition to a state of waiting for a response to the issued SCSI command from the dedicated HBA 207.

In the dedicated HBA 207 of the master computer 22M, the control unit 214 receives the SCSI command and the data, which have been transferred from the CPU 201. The control unit 214 analyzes the received SCSI command to identify the process to be executed, and executes the identified process. Since the received SCSI command issues the instruction to write data, the control unit 214 outputs the received data to the disk interface 211 (SQ11), and causes the disk interface 211 to store the received data in the storage 208 (SQ12). Moreover, the control unit 214 references the IP table 215, generates a packet 218 in which the received data and the SCSI command are stored in the data part 218b, and outputs the generated packet to the network interface 212 in the dedicated HBA 207 of each of the slave computers 22S (SQ13). Thus, the packet 218 is transmitted from the network interface 212 (SQ2). In the dedicated HBA 207 to which the SCSI command has been transferred, such a process is executed as SB1.

The packet 218 transmitted from the master computer 22M in this way is received by the dedicated HBA 207 of a corresponding slave computer 22S via the LAN 21, or via the LAN 21 and the WAN 1 (SQ2).

There are many cases, for original data, the data amount is large. Accordingly, a plural number of packets 218 that store original data are generated in many cases. Here, however, the number of packets 218 is ignored for the sake of convenience of explanation.

The network interface 212 of the dedicated HBA 207 of each of the slave computers 22S extracts a packet 218 addressed to the local dedicated HBA 207 from among received packets 218, and outputs the extracted packet to the control unit 214 (SQ14). The control unit 214 extracts data stored in the data part 218b of the input packet 218, and executes a process according to the SCSI command stored as the data. Here, since the SCSI command that provides the instruction to write data is stored in the data part 218b, the control unit 214 outputs the data to be written, which is stored in the data part 218b, to the disk interface 211, and issues the instruction to write the data to the disk interface 211 (SQ15). The disk interface 211 writes the data to be written to the storage 208 according to the instruction from the control unit 214 (SQ16). In the dedicated HBA 207 of each of the slave computers 22S, which has received the packet 218 from the master computer 22M, such a process is executed without being controlled by the CPU 201 as SC1. The CPU 201 of each of the slave computers 22S does not execute the process related to data backup.

The dedicated HBA 207 of each of the slave computers 22S transmits, to the dedicated HBA 207 of the master computer 22M, a packet 218 for notifying the dedicated HBA 207 of the master computer 22M of a result of the write to the dedicated HBA 207 after the dedicated HBA 207 of each of the slave computers 22S writes the data to the storage 208, although this is not particularly illustrated in FIGS. 5 and 6. The packet 218 transmitted to the dedicated HBA 207 of the master computer 22M is a packet in which a SCSI response is stored in the data part 218b. The dedicated HBA 207 of the master computer 22M recognizes that the data backup process has been completed by receiving the packet 218. The dedicated HBA 207 of the master computer 22M outputs the SCSI response to the CPU 201 of the master computer 22M after the dedicated HBA 207 has written the data to the storage 208. As an embodiment, the dedicated HBA 207 of the master computer 22M may output the SCSI response at a time point when the dedicated HBA 207 of the master computer 22M has written the data to a subordinate storage 208 in order to shorten the length of time that the data has been written.

When the CPU 201 of the master computer 22M issues the instruction to write data to the dedicated HBA 207 in this way, the data to be written is transmitted to the dedicated HBA 207 of each of the slave computers 22S, and is stored in the storage 208 as backup data. Since data is backed up each time the CPU 201 of the master computer 22M issues the instruction to write data to the dedicated HBA 207, it is not always connected the storage 208 to the dedicated HBA 207 equipped in the master computer 22M. When data is backed up at a predetermined timing such as a set time or the like, the storage 208 is connected to the dedicated HBA 207 equipped in the master computer 22M.

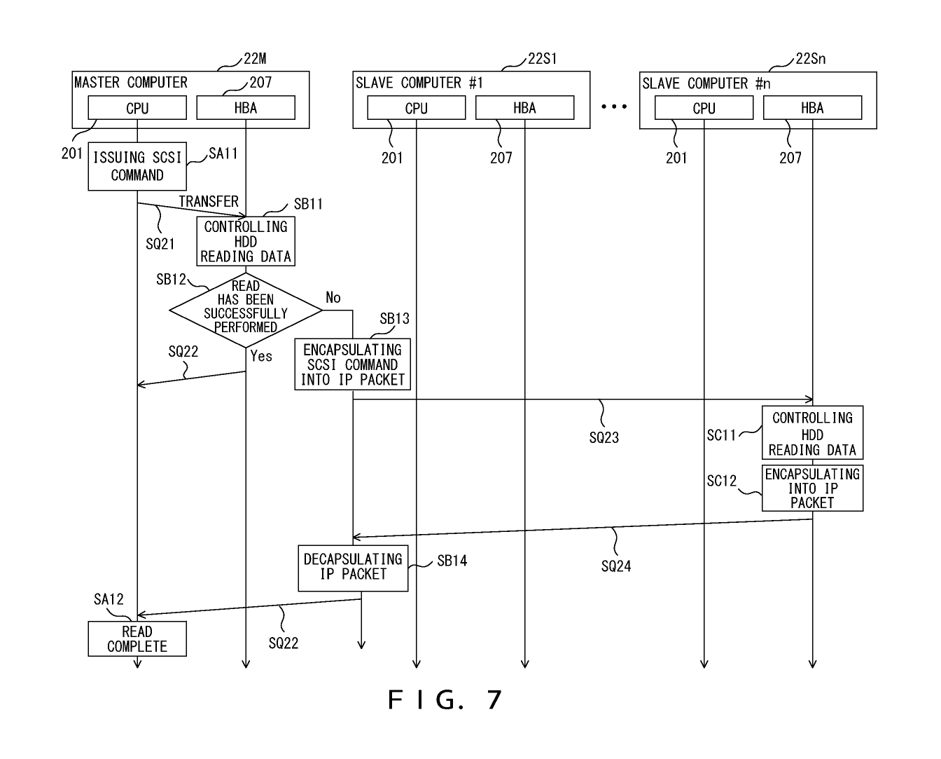

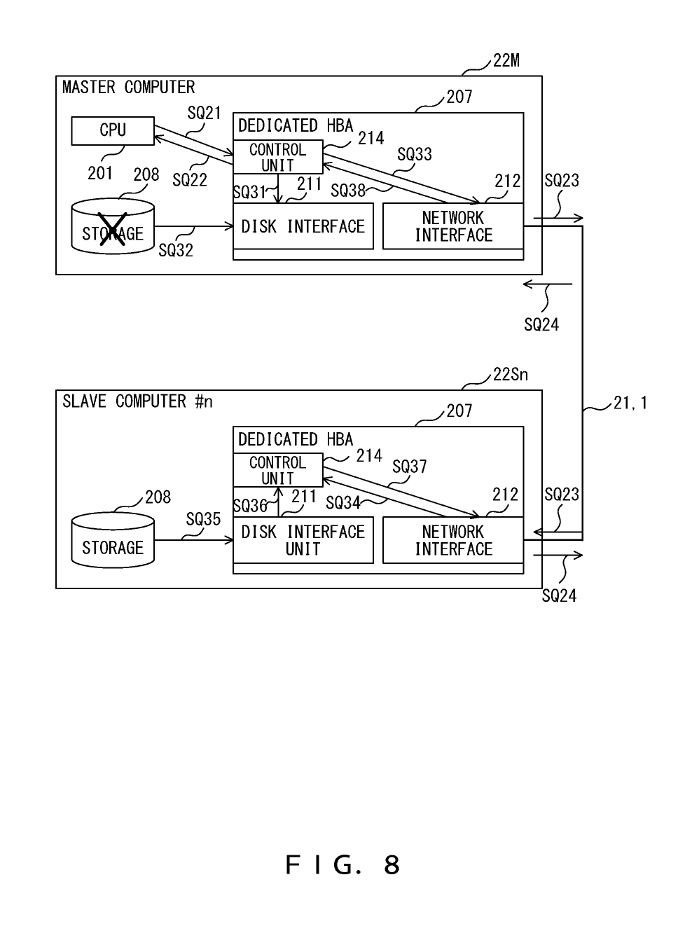

Operations of the master computer 22M and the slave computer 22S, which are performed when data is read, are specifically described next with reference to FIGS. 7 and 8. FIG. 7 is a flowchart that represents a flow of a process executed by the computers when data is read. FIG. 8 is a sequence diagram for explaining packets transmitted and received between the computers, and data inputs and outputs performed among the components of the computers.

Similarly to FIG. 5, FIG. 7 illustrates the CPU 201 and the dedicated HBA 207 as components that execute the process in the master computer 22M and the slave computers 22S. The process illustrated in FIG. 7 is executed when a situation is created such that the CPU 201 of the master computer 22M reads data of the storage 208 as described above.

When the situation is created such that the CPU 201 of the master computer 22M reads the data of the storage 208, the CPU 201 issues a SCSI command for providing an instruction to read data, and transfers the issued SCSI command to the dedicated HBA 207 (SA11, SQ21). Thereafter, the CPU 201 makes a transition to a state of waiting for a response to the issued SCSI command from the dedicated HBA 207.

In the dedicated HBA 207 of the master computer 22M, the control unit 214 receives the SCSI command transferred from the CPU 201. The control unit 214 analyzes the received SCSI command to identify a process to be executed, and executes the identified process. Since the received SCSI command provides the instruction to read data, the control unit 214 instructs the disk interface 211 to read the data requested by the SCSI command (SQ31). The disk interface 211 reads the data from the storage 208 according to the instruction from the control unit 214 (SQ32), and notifies the control unit 214 of a result of the read. In SB11, such a process is executed.

The control unit 214 determines whether the data has been successfully read, according to the notification from the disk interface 211 (SB12). When the data has not been successfully read from the storage 208, or when suitable data has not been successfully read from the storage 208, the determination in SB12 is “NO”, and the flow proceeds to SB13. When the suitable data has been successfully read from the storage 208, the determination in SB12 is “YES”. In this case, the disk interface 211 outputs the data read from the storage 208 to the control unit 214. Then, the control unit 214 outputs the data input from the disk interface 211 and a SCSI response to the CPU 201 (SQ22).

In the meantime, in SB13, the control unit 214 selects a dedicated HBA 207 of the slave computer 22S, which issues a request to transmit backup data, generates a packet 218 addressed to the selected dedicated HBA 207, and outputs the generated packet to the network interface 212 (SQ33). The packet 218 is transmitted via the network interface 212 (SQ23).

The dedicated HBA 207 to which the request to transmit backup data is issued is selected by referencing the IP table 215. FIGS. 7 and 8 assume only one slave computer 22Sn as the slave computer 22S equipped with the dedicated HBA 207 to which the request to transmit backup data is issued. In a data part 218b of the generated packet 218, the SCSI command input from the CPU 201 is stored.

The packet 218 transmitted from the master computer 22M in this way is received by the dedicated HBA 207 of the slave computer 22Sn via the LAN 21 and the WAN 1 (SQ23). When the received packet 218 is a packet 218 addressed to the local dedicated HBA 207, the network interface 212 of the dedicated HBA 207 of the slave computer 22Sn outputs the received packet 218 to the control unit 214 (SQ34).

The control unit 214 extracts data stored in the data part 218b of the input packet 218, and executes a process according to the SCSI command stored as the data. Here, since the SCSI command that provides the instruction to read data is stored in the data part 218b, the control unit 214 instructs the disk interface 211 to read the data according to the SCSI command. The disk interface 211 reads the data from the storage 208 according to the instruction from the control unit 214 (SQ35), and outputs the read data to the control unit 214 (SQ36). In SC11, such a process is executed.

Next, the control unit 214 generates a packet 218 addressed to the dedicated HBA 207 of the master computer 22M, and outputs the generated packet to the network interface 212 (SQ37). In this way, the packet 218 generated by the control unit 214 is transmitted via the network interface 212 (SQ24). In SC12, such a process is executed. In a data part 218b of the generated packet 218, the data input from the disk interface unit 211, and a SCSI response are stored. The CPU 201 of the slave computer 22Sn does not execute a process related to a read of the data, similarly to the case of data backup.

The packet 218 transmitted from the dedicated HBA 207 of the slave computer 22Sn in this way is received by the network interface 212 of the dedicated HBA 207 equipped in the master computer 22M, and the packet 218 is outputted to the control unit 214 (SQ38). The control unit 214 waits for a response after it executes the above described SB13. When the packet 218 is input from the network interface 212, the control unit 214 extracts the data stored in the data part 218b of the input packet 218, and outputs the extracted data and the SCSI response to the CPU 201 (SQ22).

The data and the SCSI response are input from the control unit 214 of the dedicated HBA 207, so that the CPU 201 recognizes that the data read has been completed (SA12). Thereafter, the CPU 201 executes a process using the data input from the dedicated HBA 207.

As described above, for a read of data stored in a storage 208, data from the storage 208 of the master computer 22M is read with the top priority. If suitable data is not obtained by this top priority read, backup data is read. The reason why the data from the storage 208 of the master computer 22M is read with the top priority is that the length of time to obtain the data is expected to be the shortest.

The dedicated HBA 207 of a slave computer 22S may fail to read suitable backup data from the storage 208. For this reason, the dedicated HBA 207 of the master computer 22M issues a request to read backup data by alternating the slave computers 22S equipped with the dedicated HBA 207 until it can obtain the suitable backup data, although this is not particularly illustrated in FIGS. 7 and 8. Thereby, if the dedicated HBA 207 of the master computer 22M does not obtain the suitable backup data from the dedicated HBA 207 of the slave computer 22Sn, the dedicated HBA 207 issues a request to read the backup data to the dedicated HBA 207 of another slave computer 22S.

In this embodiment, the master computer 22M and the slave computers 22S are implemented by being equipped with the dedicated HBA 207 placed in the master mode or the slave mode. However, the master computer 22M or at least one of the slave computers 22S may be a computer not equipped with the dedicated HBA 207. This is because an existing master computer or slave computer may be used as the master computer 22M or at least one of the slave computers 22S. For example, when data is backed up at different sites, it is sufficient to newly set up a slave computer, and an existing master computer is available unchanged. When the master computer is temporarily replaced with another computer, or when a computer set up at a different site is newly used as the master computer, an existing slave computer is available unchanged. Thus, neither the master computer 22M nor the slave computers 22S always need to be implemented by using a dedicated HBA 207.

Additionally, in this embodiment, an existing SCSI command is transmitted and received by using a packet 218 between dedicated HBAs 207. This is because existing functions are effectively used, partially because HBA normally supports SCSI commands. However, if it is assumed that there is only a communication between dedicated HBAs 207, commands supported only by the dedicated HBAs 207 may be transmitted and received.

As described above, in one system to which this embodiment is applied, a data backup environment can be built faster and at lower cost.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data backup method, comprising:
equipping a first computer with an interface card having an access function of accessing a storage and a communication function of performing a communication via a network;
connecting the interface card equipped in the first computer and a second computer by the network; and
causing the interface card to process target data received from the second computer and to cause the target data to be saved in a first storage, which is a storage connected to the interface card, when the second computer transmits the target data to be saved to the interface card.

2. The data backup method according to claim 1, further comprising:
equipping the second computer with a different interface card having a communication function of performing a communication via the network and a storage configured to save transmission destination information that represents an interface card, which is a transmission destination of the target data input from the second computer; and
causing the different interface card to transmit the target data to the interface card represented by the transmission destination information saved in the storage when the target data is output from the second computer to the different interface card.

3. The data backup method according to claim 2, wherein
the different interface card has an access function of accessing a storage, the method further comprising
saving the target data in a second storage, which is a storage connected to the different interface card, when the target data is input from the second computer.

4. The data backup method according to claim 3, wherein
the different interface card reads the target data from the second storage when a request of the target data is issued from the second computer, and issues a request to transmit the target data to the interface card represented by the transmission destination information saved in the storage when suitable target data is not obtained with the read.

5. A data backup method, comprising:
equipping a first computer with an interface card having a communication function of performing a communication via a network and a storage configured to save transmission destination information that represents a transmission destination of data input from the first computer;
connecting the interface card equipped in the first computer and a second computer to the network;
causing the interface card to transmit target data to the transmission destination represented by the transmission destination information saved in the storage when the target data to be saved is output from the first computer to the interface card; and
causing the second computer to process the target data received from the interface card, and to save the target data in a first storage, which is a storage accessible by the second computer.

6. The data backup method according to claim 5, further comprising:
equipping the second computer with a different interface card having an access function of accessing the first storage and a communication function of performing a communication via the network;
connecting the interface card equipped in the first computer and the different interface card equipped in the second computer to the network; and
causing the interface card to transmit the target data to the different interface card represented by transmission destination information saved in the storage by saving the transmission destination information, which represents the different interface card as the transmission destination, in the storage of the interface card, when the first computer outputs the target data to the interface card.

7. An interface card used by being equipped in a computer, the interface card comprising:
a disk interface configured to access an accessible storage;
a network interface configured to perform a communication via a connected network; and
a processor configured to cause the data to be saved in the storage by using the access unit when the communication unit receives the data via the network.
